(19) United States
(12) Patent Application Publication
(10) Pub. No.: US 2026/0126673 A1
(43) Pub. Date: May 7, 2026

(54) EYEWEAR HALTER ASSEMBLY

(71) Applicant: Craig Crowe, Houston, TX (US)

(72) Inventor: Craig Crowe, Houston, TX (US)

(21) Appl. No.: 18/940,479

(22) Filed: Nov. 7, 2024

(51) Int. Cl. G02C 11/02; G02C 5/14

(52) U.S. Cl. CPC G02C 11/02; G02C 5/14

(57) ABSTRACT

An eyewear halter assembly for detachably connecting decorative elements to eyewear includes a temple support and a temple decorative assembly. The temple support includes a temple plate and a temple clip arm attached to the temple plate. The temple clip arm is resiliently flexible to detachably connect the temple plate to a temple of eyewear with the temple of the eyewear gripped between the temple plate and the temple clip arm. The temple support includes a temple housing mounted on and projecting perpendicularly from the temple plate. The temple decorative assembly includes a temple decorative frame. The temple decorative frame includes a recessed portion that is designed to detachably connect onto the housing in a form fit. The temple decorative assembly includes a temple decorative structure attached to the temple decorative frame. Other decorative components for the head and torso are connectable to the temple support and the eyewear.

### (b) Cross-reference to Related Applications

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention.

The disclosure relates to decorative eyewear accessories and more particularly pertains to a new eyewear halter assembly for providing wearers with a customizable system for producing countless decorative presentations for the head and torso area, regardless of the type of eyewear, such as eyeglasses or sunglasses, that the wearer decides to wear or is required to wear.

### (2) Description of Related Art including information disclosed under 37 CFR 1.97 and 1.98

The prior art relates to decorative eyewear accessories. The prior art, as best understood, does not disclose an eyewear halter assembly for detachably connecting decorative elements to eyewear includes a temple support and a temple decorative assembly that includes a temple decorative structure attached to the temple decorative frame. The prior further does not disclose additional components, such as a chest support, a crown support, a brow support, a back support, a rim support, and a bridge clip, as part of the eyewear halter assembly.

### (h) BRIEF SUMMARY OF THE INVENTION

An embodiment of the disclosure meets the needs presented above in an eyewear halter assembly for detachably connecting decorative elements to eyewear generally comprising a temple support and a temple decorative assembly. The temple support includes a temple plate and a temple clip arm attached to the temple plate. The temple clip arm is resiliently flexible to detachably connect the temple plate to a temple of eyewear with the temple of the eyewear gripped between the temple plate and the temple clip arm. The temple support includes a temple housing mounted on and projecting perpendicularly from the temple plate. The temple decorative assembly includes a temple decorative frame. The temple decorative frame includes a recessed portion that is designed to detachably connect onto the housing in a form fit. The temple decorative assembly includes a temple decorative structure attached to the temple decorative frame. In one possible embodiment, the eyewear halter assembly further includes at least one of: a chest support, a crown support, a brow support, a back support, a rim support, and a bridge clip.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of an eyewear halter assembly according to an embodiment of the disclosure.

FIG. 2 is a side view of an embodiment of the disclosure.

FIG. 3 is a perspective view of a component of an embodiment of the disclosure.

FIG. 4 is a side cross-sectional view of a component of an embodiment of the disclosure.

FIG. 5 is a rear view of a component of an embodiment of the disclosure.

FIG. 6 is a perspective view of a component of an embodiment of the disclosure.

FIG. 7 is a perspective view of a component of an embodiment of the disclosure.

FIG. 8 is a perspective view of a component of an embodiment of the disclosure.

FIG. 9 is a rear view of a component of an embodiment of the disclosure.

FIG. 10 is a rear view of a component of an embodiment of the disclosure.

FIGS. 11a, 11b, 11c, and 11d show location areas of components of an embodiment of the disclosure when worn by a person.

### (j) DETAILED DESCRIPTION OF THE INVENTION

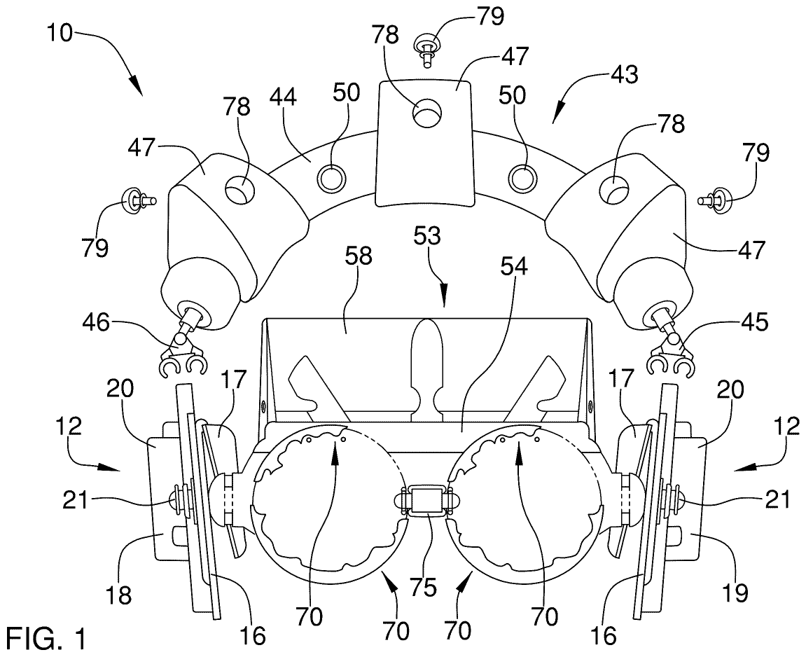

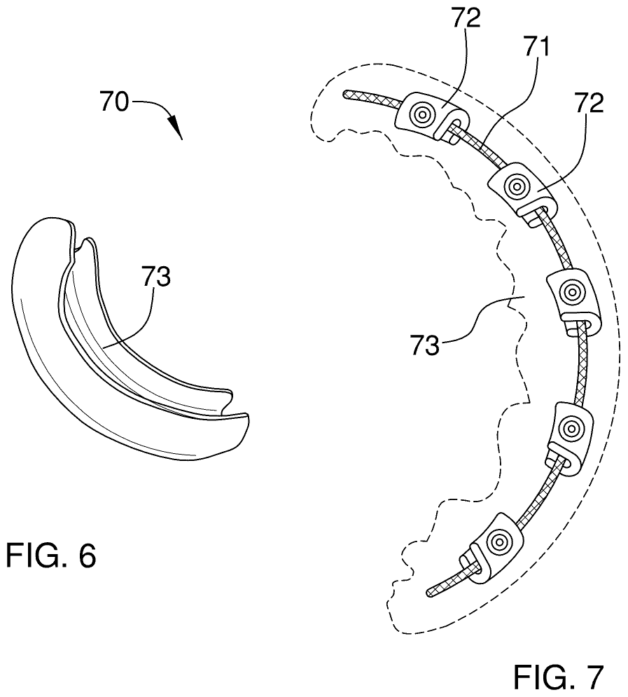

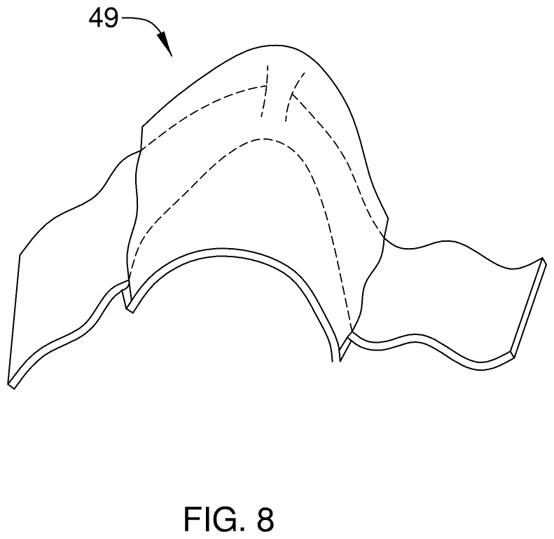

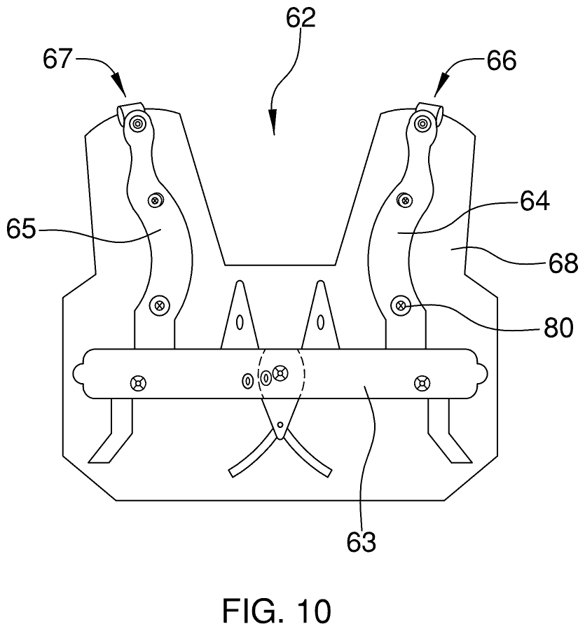

With reference now to the drawings, and in particular to FIGS. 1 through 11d thereof, a new eyewear halter assembly embodying the principles and concepts of an embodiment of the disclosure and generally designated by the reference numeral 10 will be described.

As best illustrated in FIGS. 1 through 11d, the eyewear halter assembly 10 generally comprises a temple support 12 and a temple decorative assembly 14. The temple support 12 includes a temple plate 16 and a temple clip arm 17 attached to the temple plate 16. The temple clip arm 17 is resiliently flexible to detachably connect the temple plate 16 to a temple 101 of eyewear 100 with the temple 101 of the eyewear 100 gripped between the temple plate 16 and the temple clip arm 17. The temple support 12 includes a temple housing 20 mounted on and projecting perpendicularly from the temple plate 16. The temple decorative assembly 14 includes a temple decorative frame 22. The temple decorative frame 22 includes a recessed portion 23 that is designed to detachably connect onto the temple housing 20 in a form fit. The temple decorative assembly 14 includes a temple decorative structure 24 attached to the temple decorative frame 22.

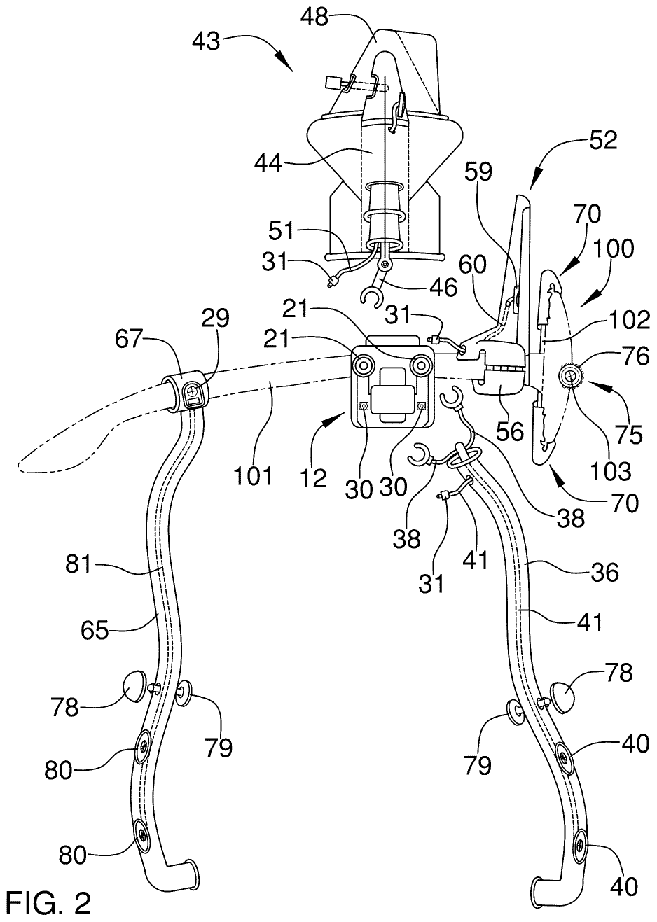

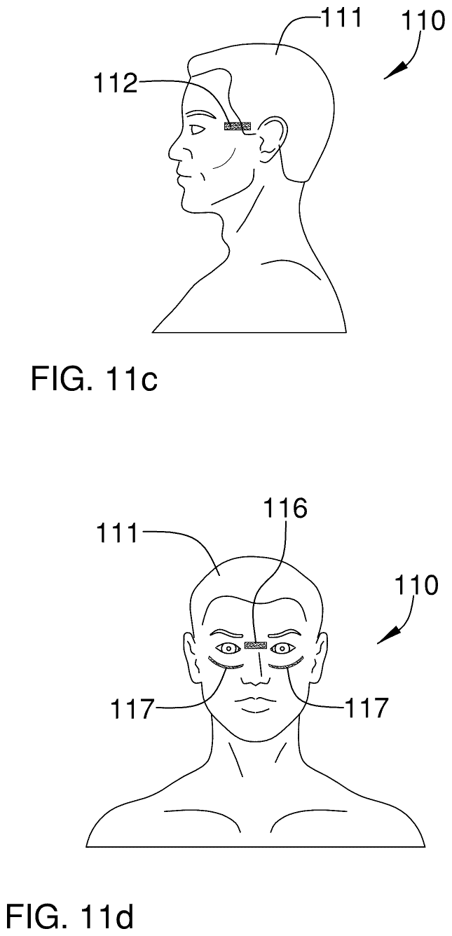

In the exemplary embodiment in FIG. 1, the temple support 12 is a right temple support 18 designed to be detachably connected to a right temple 101 of the eyewear 100, and the eyewear halter assembly 10 further includes a left temple support 19 designed to be detachably connected to a left temple 101 of the eyewear 100. Each of the left temple support 19 and the right temple support 18 includes a plurality of temple support posts 21 projecting from the temple plate 16 adjacent the temple housing 20, as shown in FIGS. 1 and 2. The temple support 12 is located near the temple region 112 of a person 110, as marked in FIG. 11c.

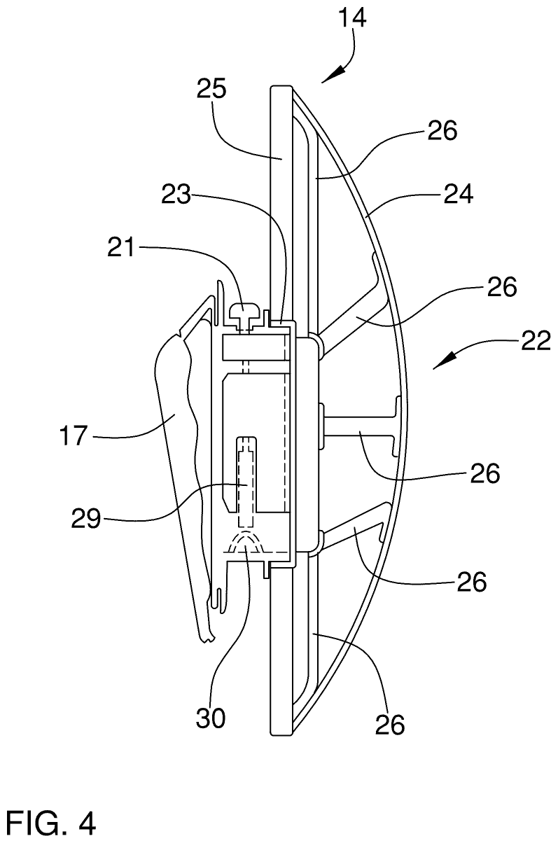

FIG. 4 shows a cross-section of an exemplary embodiment of the temple support 12 and temple decorative assembly 14. The temple decorative frame 22 has an outer temple decorative panel 24, an inner temple decorative panel 25, and reinforcing elements 26 connected in between. The temple clip arm 17 is angled inwardly. A battery 29 is positioned in the temple housing 20. The battery 29 could be in either or both of the left temple support 19 and the right temple support 18. A plurality of wire receptacles 30 is positioned in the temple housing 20 and connected to the battery 29, as shown in FIGS. 2 and 4. The battery 29 and wire receptacles 30 are used to connect to different components that require power for illumination, as will be discussed herein.

The temple support 12 forms the foundation for the eyewear halter assembly 10, which has multiple components, some of which detachably connect to and are supported on the temple support 12. It should be noted that any of the components disclosed herein may be used in any combination in the eyewear halter assembly 10, or possibly independently in at least one possible embodiment. The components generally are in the form of a support and a decoration detachably connected to the support. The decorations can be of virtually any design, such as plates, arches, visors, strings of elements, and replicas of objects, creatures, or plants, and can include any type of colors and design features, such as patterns, shapes, images, and text. The eyewear halter assembly 10 is a comprehensive system for creating innumerable decorative presentations that can be placed on or suspended from eyewear regardless of style, such as square, rounded, wire, plastic, or other types of frames. It should also be noted that the supports and decorations are detachably connectable a snap-fit or quick-connect style of connecting structures with male and female members as shown in the exemplary embodiments in the figures.

However, most any kind of detachable connecting structures, such as snaps, buttons, clasps, hooks, clamps, tabs, gripping arms, and zippers, could be utilized to connect the various components, and the positions of any male and female members could be reversed from the design shown, as is well known in the apparel industry. All components are generally made of plastic, but could incorporate lightweight metals and possibly glass, as well as rubbers and elastomers for comfort or gripping.

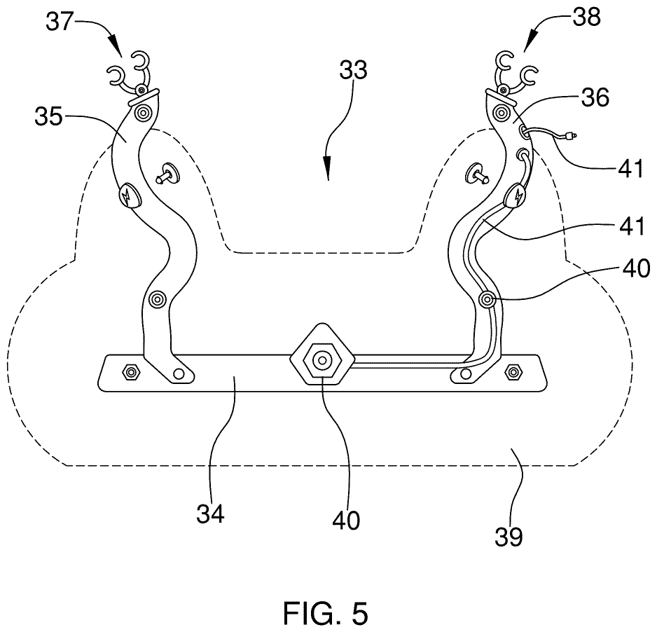

With reference to FIGS. 2 and 5, the eyewear halter assembly 10 further includes a chest support 33 designed to be suspended from the eyewear 100. It should be noted that FIG. 2 shows only one side of the eyewear halter assembly 10, but this view is equally applicable to the left and right sides of the eyewear halter assembly 10. As shown in FIG. 5, the chest support 33 includes a chest frame 34 to be placed abutting a front torso 113 of a person 110, as marked in FIG. 11a. The chest support 33 includes a left chest cable 35 and a right chest cable 36 attached to and extending from respective left and right ends of the chest frame 34. The left chest cable 35 includes a left chest clip arm 37 detachably connected to an associated one of the temple support posts 21 of the left temple support 19. The right chest cable 36 includes a right chest clip arm 38 detachably connected to an associated one of the temple support posts 21 of the right temple support 18. In the exemplary embodiment, an additional left chest clip arm 37 and right chest clip arm 38 is included to produce four connection points. The chest support 33 includes a plurality of female receptacles 78 positioned on the chest frame 34, the left chest cable 35, and the right chest cable 36. A chest decorative structure 39 includes a plurality of male projections 79 detachably connected to an associated one of the female receptacles 78. In one possible embodiment, a plurality of chest lights 40 can be positioned in the chest support 33. A chest wire 41 is positioned in the chest support 33 and connected to the plurality of chest lights 40. The chest wire 41 includes a connector plug 31 designed to detachably connect the chest wire 41 to an associated one of the wire receptacles 30 in the temple housing 20.

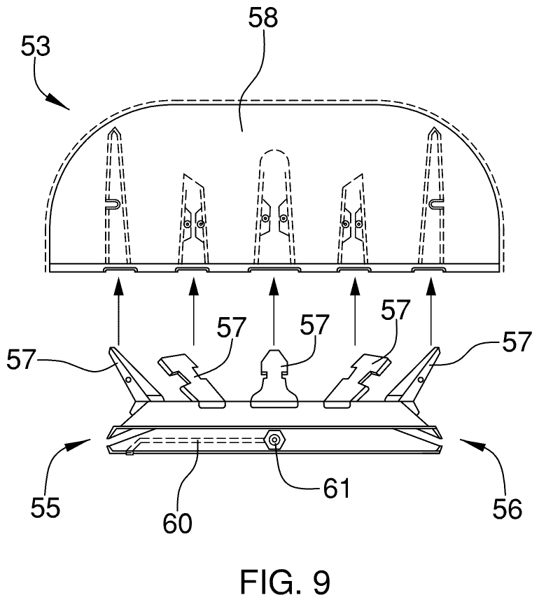

With reference to FIGS. 1 and 2, the eyewear halter assembly 10 further includes a crown support 43 designed to be mounted on the eyewear 100. The crown support 43 includes a crown frame 44. The crown frame 44 is in the form of an arch to be placed over a head 111 of a person 110, as marked in FIG. 11a. The crown support 43 includes a left crown clip arm 45 positioned at a left end of the crown frame 44 and a right crown clip arm 46 positioned at a right end of the crown frame 44. The left crown clip arm 45 is detachably connected to an associated one of the temple support posts 21 of the left temple support 19. The right crown clip arm 46 is detachably connected to an associated one of the temple support posts 21 of the right temple support 18. The crown support 43 includes a plurality of crown support projections 47 extending upwardly from the crown frame 44. A crown decorative structure 48 is detachably connected to the crown support projections 47. The shape, orientation, and number of the crown support projections 47 can be customized as desired at the time of manufacture. As shown in FIG. 8, in one possible embodiment the crown support 43 includes a resilient strap 49 connectable to the crown frame 44. The resilient strap 49 is designed to be wrapped onto the head 111 of the person 110. The strap 49 could be made of stretchable resilient fabric. A plurality of crown lights 50 is positioned in the crown support 43. A crown wire 51 is positioned in the crown support 43 and connected to the plurality of crown lights 50. The crown wire 51 includes a connector plug 31 designed to detachably connect the crown wire 51 to an associated one of the wire receptacles 30 in the temple housing 20.

With reference to FIGS. 1, 2, and 9, the eyewear halter assembly 10 further includes a brow support 53 designed to be mounted on the eyewear 100. The brow support 53 includes a brow frame 54. The brow frame 54 is in the form of a plate to be placed in front of a forehead 115 of a person 110, as marked in FIG. 11a. The brow support 53 includes a left brow clip arm 55 extending downwardly from a left end of the brow frame 54 and a right brow clip arm 56 extending downwardly from a right end of the brow frame 54. The left brow clip arm 55 is designed to be detachably connected to the left temple 101 of the eyewear 100. The right brow clip arm 56 is designed to be detachably connected to the right temple 101 of the eyewear 100. The brow support 53 includes a plurality of brow support projections 57 extending upwardly from the brow frame 54. A brow decorative structure 58 is detachably connected to the brow support projections 57. The shape, orientation, and number of the brow support projections 57 can be customized as desired at the time of manufacture. A brow light 59 is positioned in the brow support 53. A brow wire 60 is positioned in the brow support 53 and connected to the brow light 59. The brow wire 60 includes a connector plug 31 designed to detachably connect the brow wire 60 to an associated one of the wire receptacles 30 in the temple housing 20.

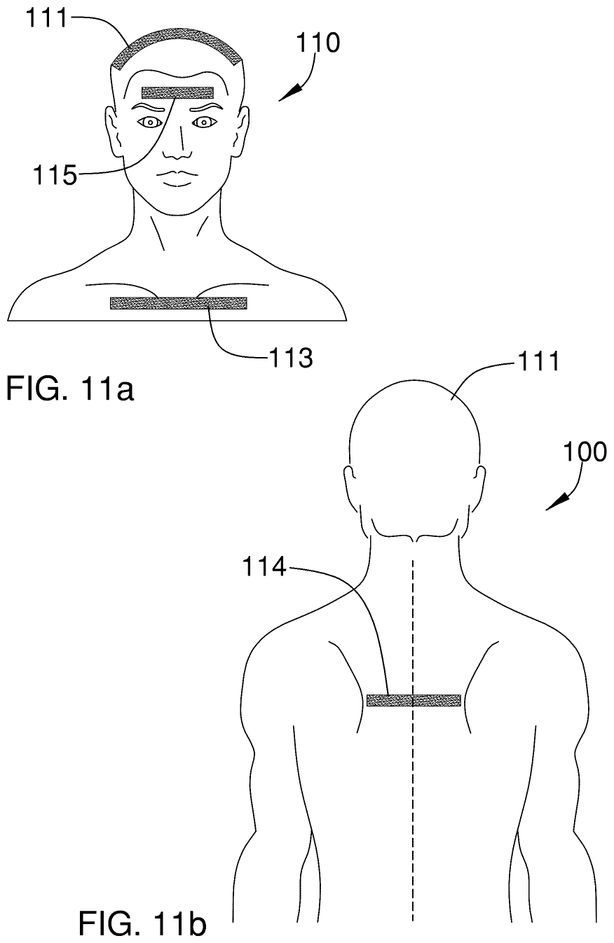

With reference to FIGS. 2 and 10, the eyewear halter assembly 10 further includes a back support 62 designed to be suspended from the eyewear 100. The back support 62 includes a back frame 63 to be placed abutting a rear torso 114 of a person 110, as marked in FIG. 11b. The back support 62 includes a left back cable 64 and a right back cable 65 attached to and extending from respective left and right ends of the back frame 63. The left back cable 64 includes a left back clip arm 66 detachably connected to an end of the left temple 101 of the eyewear 100. The right back cable 65 includes a right back clip arm 67 detachably connected to an end of the right temple 101 of the eyewear 100. The back support 62 includes a plurality of female receptacles 78 positioned on the back frame 63, the left back cable 64, and the right back cable 65. A back decorative structure 68 includes a plurality of male projections 79 detachably connected to an associated one of the female receptacles 78. The back support 62 could also include back lights 80, a back wire 81, and a battery 29.

With reference to FIGS. 1, 2, 6, and 7, the eyewear halter assembly 10 further includes a rim support 70 designed to be mounted on the eyewear 100, such as adjacent the under eye region 117 of the person 110, as marked in FIG. 11d. The rim support 70 includes a rim frame 71. The rim frame 71 is in the form of a curved wire shaped to conform to a rim 102 of the eyewear 100. The rim support 70 includes a plurality of rim clip arms 72 attached to the rim frame 71. Each of the rim clip arms 72 has a U-shaped cross-sectional profile designed to be detachably connected to the rim 102 of the eyewear 100. A rim decorative structure 73 is attached to the rim support 70. The rim decorative structure 73 is in the form of a curved shell designed to fit onto the rim of the eyewear 100. More than one rim support 70 can be detachably connected to the rim 102 of the eyewear 100, as shown in the figures.

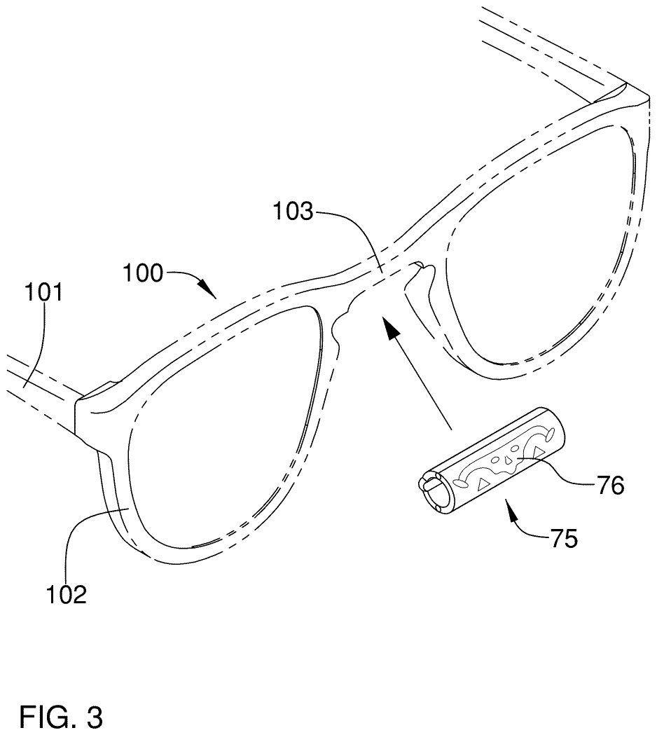

With reference to FIGS. 1 and 3, the eyewear halter assembly 10 further includes a bridge clip 75 designed to be detachably connected to a bridge 103 of the eyewear 100 at the bridge of the nose 116 of the person 110, as marked in FIG. 11d. The bridge clip 75 is in the form of a tube. The bridge clip 75 is openable to permit placement onto the bridge of the eyewear 100. A bridge decorative structure 76 is attached to an outer surface of the bridge clip 75. The bridge decorative structure 76 could be integral to the bridge clip 75 or a detachable piece wrapped or clipped onto the bridge clip 75.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An eyewear halter assembly for detachably connecting decorative elements to eyewear comprising:
a temple support including a temple plate and a temple clip arm attached to said temple plate, said temple clip arm being resiliently flexible to detachably connect said temple plate to a temple of eyewear with the temple of the eyewear gripped between said temple plate and said temple clip arm, said temple support including a temple housing mounted on and projecting perpendicularly from said temple plate; and
a temple decorative assembly including a temple decorative frame, said temple decorative frame including a recessed portion being configured to detachably connect onto said temple housing in a form fit, said temple decorative assembly including a temple decorative structure attached to said temple decorative frame.

2. The eyewear halter assembly of claim 1, wherein:
said temple support is a right temple support configured to be detachably connected to a right temple of the eyewear, and the eyewear halter assembly further comprises a left temple support configured to be detachably connected to a left temple of the eyewear; and
each of said left temple support and said right temple support includes a plurality of temple support posts projecting from said temple plate adjacent said temple housing.

3. The eyewear halter assembly of claim 2, wherein the eyewear halter assembly further comprises:
a chest support configured to be suspended from the eyewear, said chest support includes a chest frame to be placed abutting a front torso of a person, said chest support includes a left chest cable and a right chest cable attached to and extending from respective left and right ends of said chest frame, said left chest cable includes a left chest clip arm detachably connected to an associated one of said temple support posts of said left temple support, said right chest cable includes a right chest clip arm detachably connected to an associated one of said temple support posts of said right temple support, said chest support includes a plurality of female receptacles disposed on said chest frame, said left chest cable, and said right chest cable; and
a chest decorative structure, said chest decorative structure includes a plurality of male projections detachably connected to an associated one of said female receptacles.

4. The eyewear halter assembly of claim 3, wherein the eyewear halter assembly further comprises:
a battery disposed in said temple housing of at least one of said left temple support and said right temple support;
a plurality of wire receptacles disposed in said temple housing and connected to said battery;
a plurality of chest lights disposed in said chest support; and
a chest wire disposed in said chest support and connected to said plurality of chest lights, said chest wire including a connector plug configured to detachably connect said chest wire to an associated one of said wire receptacles in said temple housing.

5. The eyewear halter assembly of claim 2, wherein the eyewear halter assembly further comprises:
a crown support configured to be mounted on the eyewear, said crown support includes a crown frame, said crown frame is in the form of an arch to be placed over a head of a person, said crown support includes a left crown clip arm disposed at a left end of said crown frame and a right crown clip arm disposed at a right end of said crown frame, said left crown clip arm is detachably connected to an associated one of said temple support posts of said left temple support, said right crown clip arm is detachably connected to an associated one of said temple support posts of said right temple support, said crown support includes a plurality of crown support projections extending upwardly from said crown frame; and
a crown decorative structure detachably connected to said crown support projections.

6. The eyewear halter assembly of claim 5, wherein said crown support includes a resilient strap connectable to said crown frame, said resilient strap is configured to be wrapped onto the head of the person.

7. The eyewear halter assembly of claim 5, wherein the eyewear halter assembly further comprises:
a battery disposed in said temple housing of at least one of said left temple support and said right temple support;
a plurality of wire receptacles disposed in said temple housing and connected to said battery;
a plurality of crown lights disposed in said crown support; and
a crown wire disposed in said crown support and connected to said plurality of crown lights, said crown wire including a connector plug configured to detachably connect said crown wire to an associated one of said wire receptacles in said temple housing.

8. The eyewear halter assembly of claim 2, wherein the eyewear halter assembly further comprises:
a brow support configured to be mounted on the eyewear, said brow support includes a brow frame, said brow frame is in the form of a plate to be placed in front of a forehead of a person, said brow support includes a left brow clip arm extending downwardly from a left end of said brow frame and a right brow clip arm extending downwardly from a right end of said brow frame, said left brow clip arm is configured to be detachably connected to the left temple of the eyewear, said right brow clip arm is configured to be detachably connected to the right temple of the eyewear, said brow support includes a plurality of brow support projections extending upwardly from said brow frame; and
a brow decorative structure detachably connected to said brow support projections.

9. The eyewear halter assembly of claim 8, wherein the eyewear halter assembly further comprises:
a battery disposed in said temple housing of at least one of said left temple support and said right temple support;
a plurality of wire receptacles disposed in said temple housing and connected to said battery;
a brow light disposed in said brow support; and
a brow wire disposed in said brow support and connected to said brow light, said brow wire including a connector plug configured to detachably connect said brow wire to an associated one of said wire receptacles in said temple housing.

10. The eyewear halter assembly of claim 1, wherein the eyewear halter assembly further comprises:
a back support configured to be suspended from the eyewear, said back support includes a back frame to be placed abutting a rear torso of a person, said back support includes a left back cable and a right back cable attached to and extending from respective left and right ends of said back frame, said left back cable includes a left back clip arm detachably connected to an end of the left temple of the eyewear, said right back cable includes a right back clip arm detachably connected to an end of the right temple of the eyewear, said back support includes a plurality of female receptacles disposed on said back frame, said left back cable, and said right back cable; and
a back decorative structure, said back decorative structure includes a plurality of male projections detachably connected to an associated one of said female receptacles.

11. The eyewear halter assembly of claim 1, wherein the eyewear halter assembly further comprises:
a rim support configured to be mounted on the eyewear, said rim support includes a rim frame, said rim frame is in the form of a curved wire shaped to conform to a rim of the eyewear, said rim support includes a plurality of rim clip arms attached to said rim frame, each of said rim clip arms has a U-shaped cross-sectional profile configured to be detachably connected to the rim of the eyewear; and
a rim decorative structure attached to said rim support, said rim decorative structure is in the form of a curved shell configured to fit onto the rim of the eyewear.

12. The eyewear halter assembly of claim 1, wherein the eyewear halter assembly further comprises:
a bridge clip configured to be detachably connected to a bridge of the eyewear, said bridge clip is in the form of a tube, said bridge clip being openable to permit placement onto the bridge of the eyewear; and
a bridge decorative structure attached to an outer surface of said bridge clip.

13. The eyewear halter assembly of claim 2, wherein the eyewear halter assembly further comprises:
a chest support configured to be suspended from the eyewear, said chest support includes a chest frame to be placed abutting a front torso of a person, said chest support includes a left chest cable and a right chest cable attached to and extending from respective left and right ends of said chest frame, said left chest cable includes a left chest clip arm detachably connected to an associated one of said temple support posts of said left temple support, said right chest cable includes a right chest clip arm detachably connected to an associated one of said temple support posts of said right temple support, said chest support includes a plurality of female receptacles disposed on said chest frame, said left chest cable, and said right chest cable;
a chest decorative structure, said chest decorative structure includes a plurality of male projections detachably connected to an associated one of said female receptacles;
a battery disposed in said temple housing of at least one of said left temple support and said right temple support;
a plurality of wire receptacles disposed in said temple housing and connected to said battery;
a plurality of chest lights disposed in said chest support;
a chest wire disposed in said chest support and connected to said plurality of chest lights, said chest wire including a connector plug configured to detachably connect said chest wire to an associated one of said wire receptacles in said temple housing;
a crown support configured to be mounted on the eyewear, said crown support includes a crown frame, said crown frame is in the form of an arch to be placed over a head of a person, said crown support includes a left crown clip arm disposed at a left end of said crown frame and a right crown clip arm disposed at a right end of said crown frame, said left crown clip arm is detachably connected to an associated one of said temple support posts of said left temple support, said right crown clip arm is detachably connected to an associated one of said temple support posts of said right temple support, said crown support includes a plurality of crown support projections extending upwardly from said crown frame, said crown support includes a resilient strap connectable to said crown frame, said resilient strap is configured to be wrapped onto the head of the person;
a crown decorative structure detachably connected to said crown support projections;
a plurality of crown lights disposed in said crown support;
a crown wire disposed in said crown support and connected to said plurality of crown lights, said crown wire including a connector plug configured to detachably connect said crown wire to an associated one of said wire receptacles in said temple housing;
a brow support configured to be mounted on the eyewear, said brow support includes a brow frame, said brow frame is in the form of a plate to be placed in front of a forehead of a person, said brow support includes a left brow clip arm extending downwardly from a left end of said brow frame and a right brow clip arm extending downwardly from a right end of said brow frame, said left brow clip arm is configured to be detachably connected to the left temple of the eyewear, said right brow clip arm is configured to be detachably connected to the right temple of the eyewear, said brow support includes a plurality of brow support projections extending upwardly from said brow frame;
a brow decorative structure detachably connected to said brow support projections;
a brow light disposed in said brow support;
a brow wire disposed in said brow support and connected to said brow light, said brow wire including a connector plug configured to detachably connect said brow wire to an associated one of said wire receptacles in said temple housing;
a back support configured to be suspended from the eyewear, said back support includes a back frame to be placed abutting a rear torso of a person, said back support includes a left back cable and a right back cable attached to and extending from respective left and right ends of said back frame, said left back cable includes a left back clip arm detachably connected to an end of the left temple of the eyewear, said right back cable includes a right back clip arm detachably connected to an end of the right temple of the eyewear, said back support includes a plurality of female receptacles disposed on said back frame, said left back cable, and said right back cable;
a back decorative structure, said back decorative structure includes a plurality of male projections detachably connected to an associated one of said female receptacles;
a rim support configured to be mounted on the eyewear, said rim support includes a rim frame, said rim frame is in the form of a curved wire shaped to conform to a rim of the eyewear, said rim support includes a plurality of rim clip arms attached to said rim frame, each of said rim clip arms has a U-shaped cross-sectional profile configured to be detachably connected to the rim of the eyewear;
a rim decorative structure attached to said rim support, said rim decorative structure is in the form of a curved shell configured to fit onto the rim of the eyewear;
a bridge clip configured to be detachably connected to a bridge of the eyewear, said bridge clip is in the form of a tube, said bridge clip being openable to permit placement onto the bridge of the eyewear; and
a bridge decorative structure attached to an outer surface of said bridge clip.
